(19) United States
(12) Patent Application Publication
(10) Pub. No.: US 2008/0135591 A1
(43) Pub. Date: Jun. 12, 2008

(54) Detachable Golf Club Carrier and Hitch for Golf Car

(76) Inventor: Robert P. Cassoni, Dayton, OH (US)

Correspondence Address: Davidson, Davidson & Kappel, LLC, 485 7th Avenue, 14th Floor, New York, NY, 10018, US

(21) Appl. No.: 11/795,427

(22) PCT Filed: Jan. 18, 2006
(86) PCT No.: PCT/US2006/001691

§ 371 Date: Jul. 17, 2007

Related U.S. Application Data
(60) Provisional application No. 60/644,763, filed on Jan. 18, 2005.

(51) Int. Cl. B60R 9/00; B62B 7/02

(52) U.S. Cl. 224/274; 280/504; 414/809

(57) ABSTRACT

A golf club carrier includes a support (10) for a golf bag, a first hitching point (16) at a bottom of the golf bag support, and a second hitching point (13) at a top of the golf bag support. A hitch frame (50) is also provided.

This claims the benefit of U.S. Provisional Ser. No. 60/644,763, filed Jan. 18, 2005, which is hereby incorporated by reference herein.

### BACKGROUND

U.S. Patent Publication Nos. 2004/0188984, 2004/173993, 2003/0173122, 2003/0057001 and 2003/0029646 describe various golf club carriers for hitching to golf cars.

### SUMMARY OF THE INVENTION

The present invention provides a golf club carrier comprising a support for a golf bag and a first hitching point at a bottom of the golf bag support and a second hitching point at a top of the golf bag support.

By having the two hitching points spaced apart a firmer connection can be made.

Preferably the second hitching point is spaced more than 60 centimeters apart from the first hitch point.

The second hitch point preferably includes a latch.

The present invention also provides a hitch frame for two golf club carriers, the hitch frame having a first hitching point at a bottom of the frame and a second hitching point located more than 60 centimeters above the first hitching point.

The present invention also provides a hitch for a golf car comprising:
at least one first attachment point for attaching to a bag strap bracket of a golf car; and
a second attachment point for attaching to a bumper of the golf car.

The hitch may support two golf club carriers or other devices.

The present invention also provides a detachable hitch for hitching a single golf club carrier to a golf car comprising:
at least one first attachment point for attachment to a golf car; and
at least one second attachment point for attachment to a golf club carrier, the hitch being carriable by the golf car independent of the golf club carrier via the first attachment point and the hitch being carriable by the golf club carrier via the second attachment point.

The present invention also provides a detachable hitch for hitching a wheeled device to a golf car comprising:
at least one first attachment point for attachment to a golf car; and
at least one second attachment point for attachment to a wheeled device, the hitch being carriable by the golf car independent of the wheeled device via the first attachment point and the hitch being carriable by the wheeled device via the second attachment point.

The present invention also provides a method for attaching a hitch to a golf car comprising:
attaching the hitch to the golf car;
attaching a wheeled device to the hitch;
transporting the hitch and the wheeled device together independently of the golf car.

The present invention also provides a golf bag carrier and hitch combination comprising:
a golf bag carrier; and
a hitch carriable by the golf bag carrier and detachable therefrom.

### BRIEF DESCRIPTION OF THE DRAWINGS

FIG. 1 shows a first embodiment of the present invention with a hitch in the golf bag bay for supporting two golf club carriers.

FIG. 2 shows a side view of the FIG. 1 embodiment with the golf club carrier connected via the two hitching points to the hitch.

FIG. 3 shows a side view of the FIG. 1 embodiment with the golf club carrier being removed via jaw or latch 13 and handle 14 from hitch tube 51, while still connected at the lower hitching point.

FIG. 4 shows the side view of the FIG. 1 embodiment with the wheel hitting the ground.

FIG. 5 shows a side view of the FIG. 1 embodiment with the second hitching point disconnected, i.e. with tube 16 away from hitch jaw 53.

FIG. 6 shows a perspective view of one embodiment of the hitch of the present invention in the golf bag bay.

FIG. 7 shows a perspective view of a second embodiment of the hitch of the present invention where the hitch is carriable by either the golf car or the golf club carrier.

FIG. 8 shows the hitch of FIG. 7 in the golf bag bay.

FIG. 9 shows the hitch of FIG. 7 being carried by the golf club carrier.

FIG. 10 shows the golf club carrier according to the present invention.

FIGS. 11 and 12 show the hitch of FIG. 7.

### DETAILED DESCRIPTION

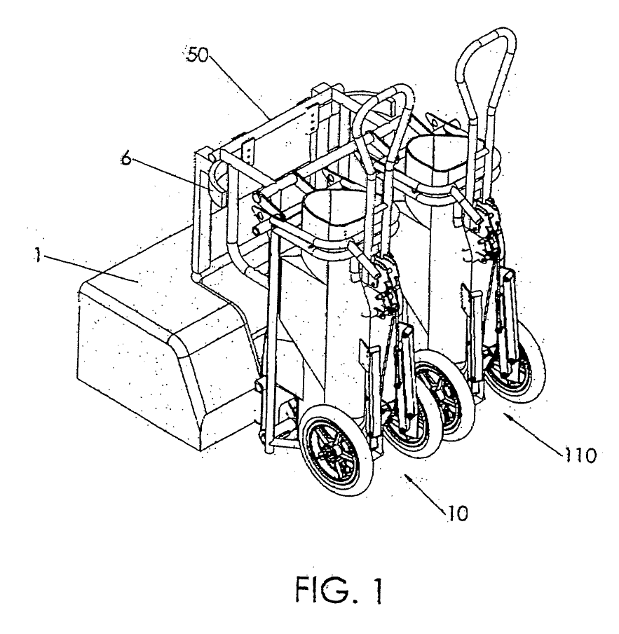

FIG. 1 shows an isometric view of the rear of a motorized golf car 1, with a two-cart hitch frame 50 installed in the bag bay. Mounted to the hitch frame are detachable golf club carriers 10, 110. The two-cart hitch frame 50 is connected to the motorized golf car 1 at the bumper and the bag strap bracket 6, but could also be attached at other locations in different embodiments. The detachable golf club carriers 10, 110 are selectively connected to the two-cart hitch frame 50.

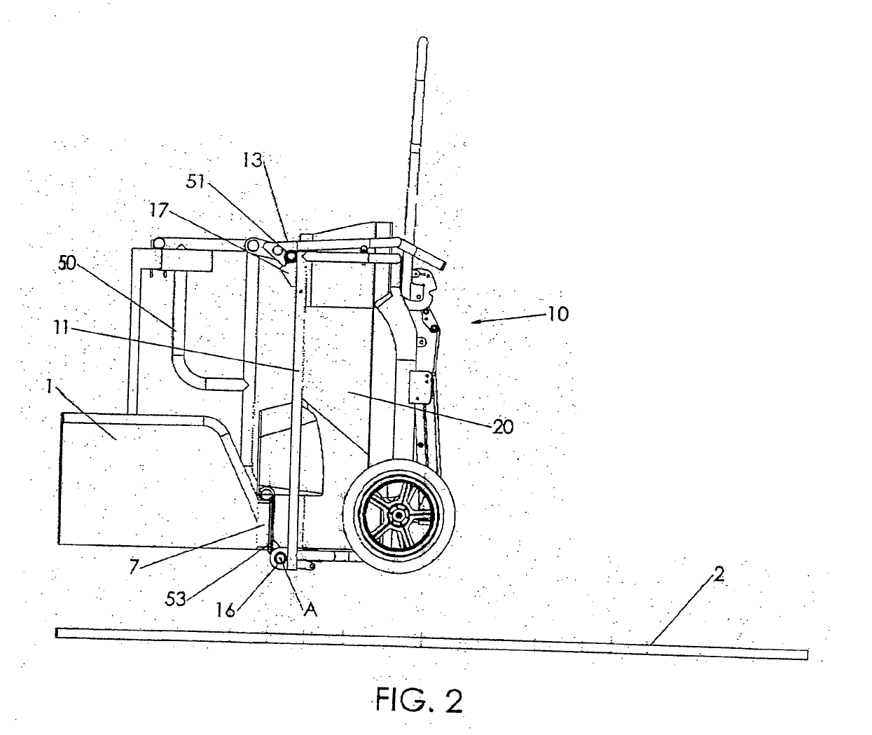

FIG. 2 shows a side view of the detachable golf club carrier 10 in the fully stowed position above the ground 2. A lower hitch tube 16 of the detachable golf club carrier 10, defining a lower hitch point of the carrier 10, rests in the lower hitch jaw 53, which defines a lower hitch point of the frame 50. An upper hitch jaw 13 of the detachable golf club carrier 10, defining an upper hitch point of the carrier 10, is connected to an upper hitch tube 51 of the two-cart hitch frame 50, which defined an upper hitching point of the frame 50. An upper hitch bracket 17 of the detachable golf club carrier 10 contacts the bottom of upper hitch tube 51 preventing upward motion of the detachable golf club carrier 10. A removable golf bag 20 is shown secured to the carrier frame body or bag support 11 of the detachable golf club carrier 10, but could also be an integral and non-removable part of the detachable golf club carrier 10.

The first hitching point for the carrier 10 thus may be at the bottom of the support 11, and the second hitching point at the top of support 11, which thus provides advantageously good spacing and thus better stability and stiffness for the attachment of the carrier 10 the frame 50. The distance between the two hitching points preferably is at least 60 cm, and most preferably at least 80 centimeters.

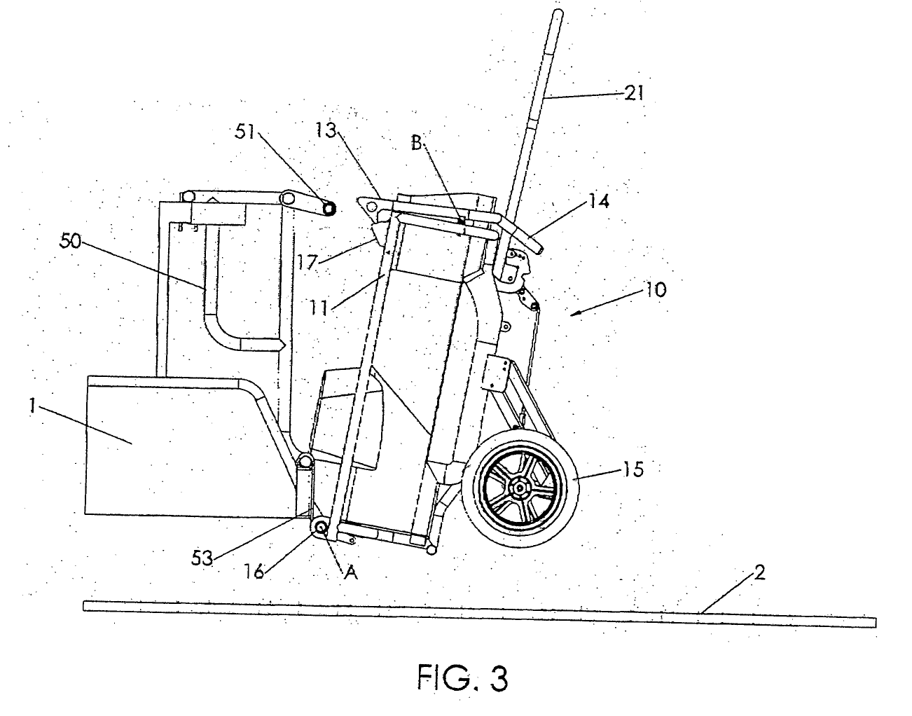

FIG. 3 shows a side view of the detachable golf club carrier 10 in the initial stage of detachment. To begin the detachment process, an upper hitch jaw handle 14 is depressed causing a clockwise rotation of upper hitch jaw or latch 13 relative to carrier frame body 11 about axis B releasing contact between upper hitch jaw 13 and upper hitch tube 51. The detachable golf club carrier 10 is then lowered towards the ground 2 by rotating the lower hitch tube 16 about axis A. Support at a carrier handle 21 controls the rate of detachment. The wheel 15 begins to move outwards from the carrier frame body 11 in preparation for contact with the ground 2. The wheel 15 could move out from the carrier frame body 11 through the influence of gravity or through a mechanism. For example, this mechanism could be a spring mechanism that pushes the wheel 15 outwards. During attachment, the spring could be overcome by a cable or linkage mechanism that is actuated through the pivoting motion of the detachable golf club carrier 10 about axis A. This would have the effect of pulling the wheel 15 towards the carrier frame body 11 for compact storage. Other mechanisms such as linkages contacting the ground during detachment to push the wheel 15 out or manual mechanisms that would involve the direct interaction of the operator to perform the opening or closing of the wheel 15 could also be used.

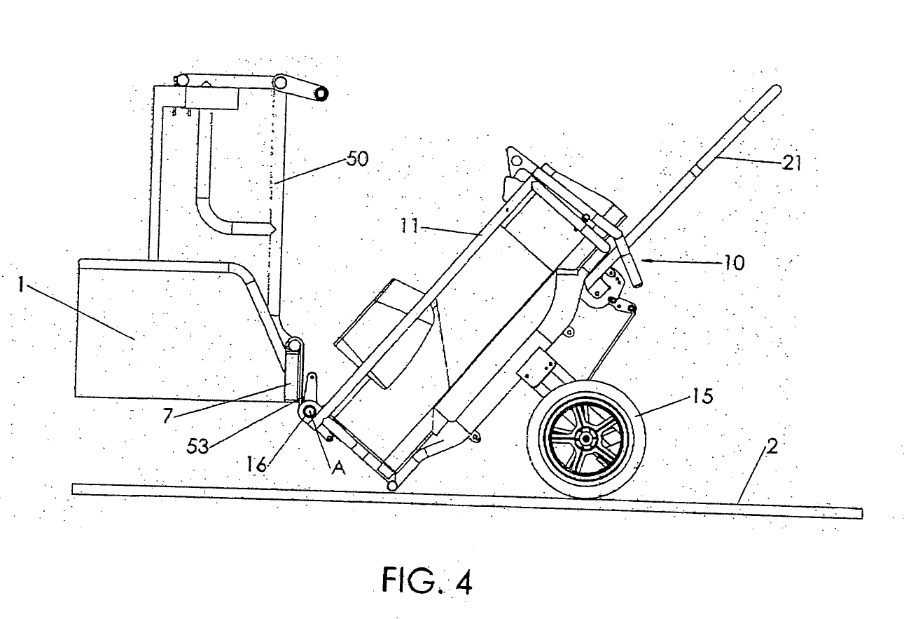

FIG. 4 shows a side view of the detachable golf club carrier 10 as the rotation about axis A has continued until the wheel 15 has contacted the ground 2.

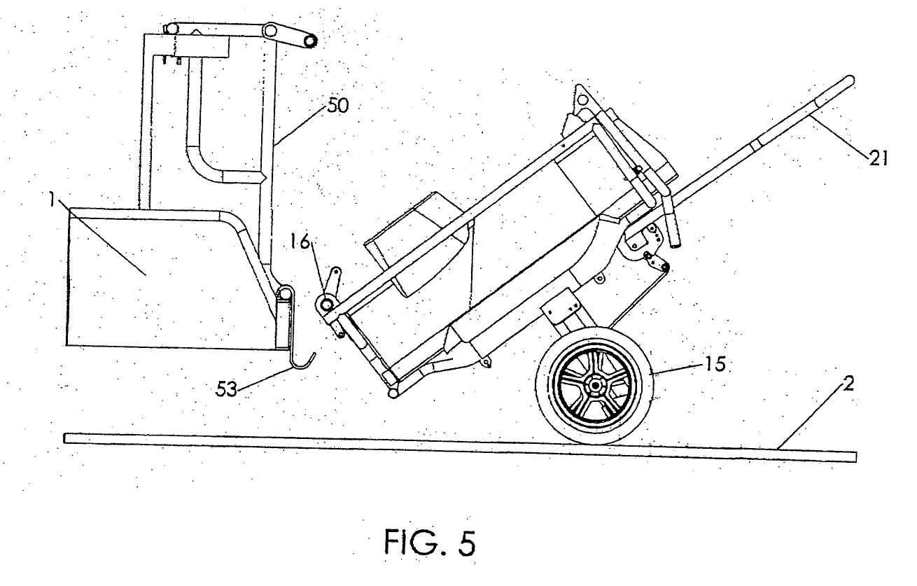

FIG. 5 shows a side view of the detachable golf club carrier 10 as handle 21 is pushed down and the detachable golf club carrier 10 rotates about the wheel 15 to remove lower hitch tube 16 from lower hitch jaw 53. The detachable golf club carrier 10 is completely disconnected from the two-cart hitch frame 50.

It should be noted that the procedure to attach the detachable golf club carrier 10 is the reverse of the sequence shown to detach.

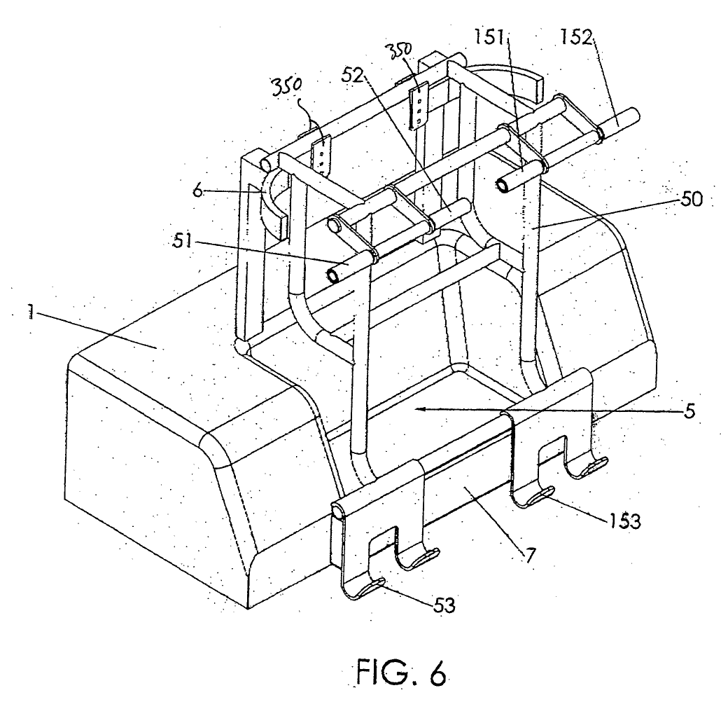

FIG. 6 shows a rear isometric view of the motorized golf car 1 with the two-cart hitch frame 50 installed. Shown clearly are the lower hitch jaws 53, 153 and the upper hitch tubes 51, 52, 151, 152. The two-cart hitch frame 50 is connected to the bumper 7 and the bag strap bracket 6 in the bag bay 5 for example via the brackets 350 shown, but could also be connected to various other areas of a motorized golf car 1 in other embodiments. A part of the frame preferably rests on the car bag bay for support. The two-cart hitch frame 50 could also be collapsible allowing a golfer to put a golf bag into the bag bay 5 in the standard method motorized golf carts are currently used. To use detachable golf club carriers, the two-cart hitch frame could be un-collapsed to provide the hitch functionality.

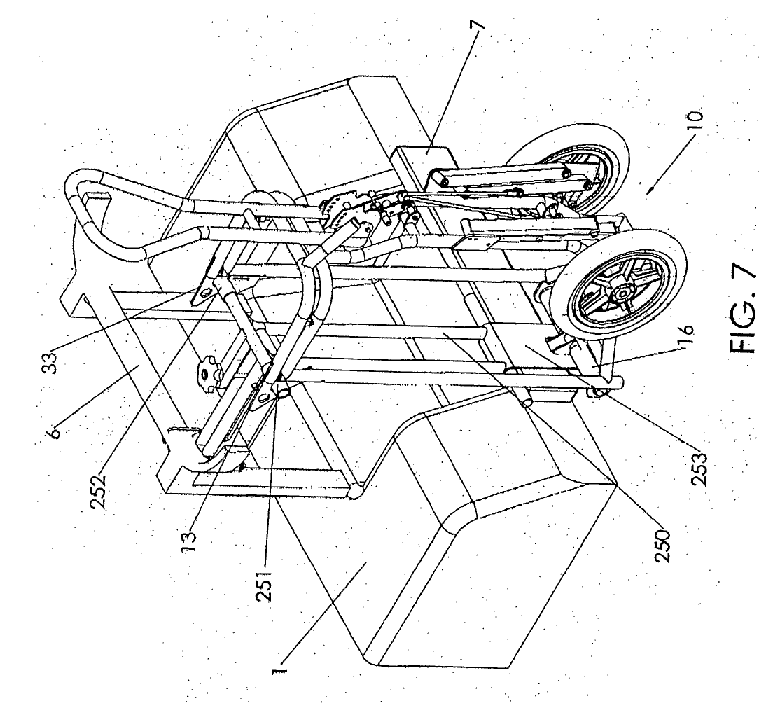

FIG. 7 shows a rear isometric view of a motorized golf car 1 with a single-cart collapsible hitch 250 installed. The single-cart collapsible hitch 250 is attached to the bumper 7 and bag strap bracket 6 of the motorized golf car 1, but could also be attached to various other areas of the motorized golf car 1 in other embodiments. The detachable golf club carrier 10 is connected to the single-cart collapsible hitch 250 through several connections. The lower hitch tube 16 of the detachable golf club carrier 10 rests in the lower hitch jaw 253 of the single-cart collapsible hitch 250. The upper hitch jaws 13, 33 are connected respectively to the upper hitch tubes 251, 252.

The sequence to attach and detach the detachable golf club carrier 10 to and from the single-cart collapsible hitch 250 is identical to the procedure shown in FIGS. 3-5 for the attachment and detachment of the detachable golf club carrier 10 to the two-cart hitch frame 50.

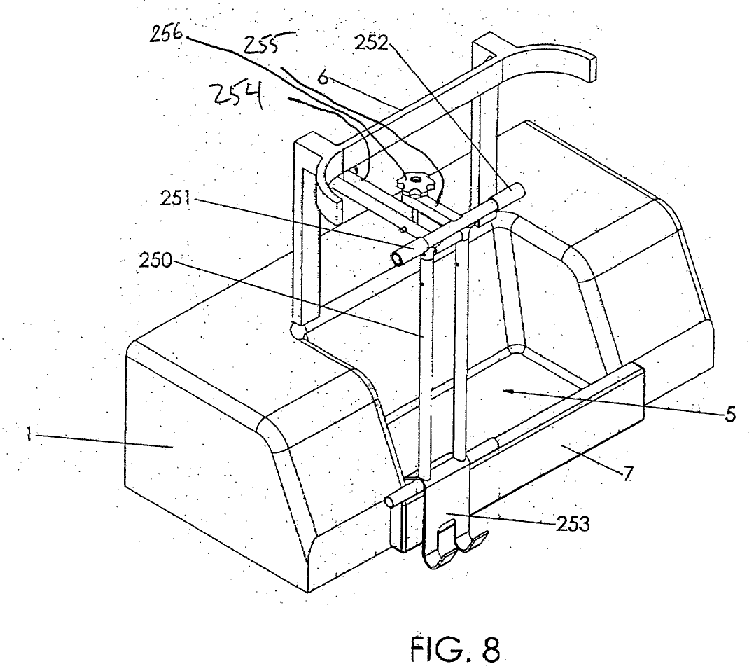

FIG. 8 shows a rear isometric view of the single-cart collapsible hitch 250 installed in the bag bay 5 of a motorized golf car 1. The single-cart collapsible hitch 250 is connected to bumper 7 and bag strap bracket 6 of motorized golf car 1. The lower hitch jaw 253 and upper hitch tubes 251, 252 are shown. An extension 254 is pivotable to contact the bracket 6 when the hitch 250 is connected to the golf car 1. A bracket 255 for a removable screw support 256 attached to extension 254 can be used to support the extension 254 in this position.

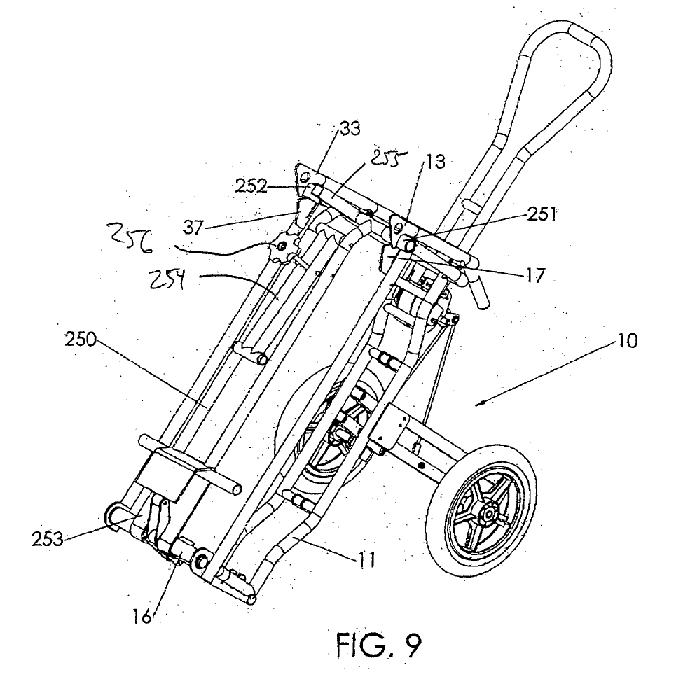

FIG. 9 shows an isometric view of the detachable golf club carrier 10 with the single-cart collapsible hitch 250 collapsed and connected for easy and convenient transport of the entire system when the single-cart collapsible hitch 250 is not being used. The extension 254 pivots downwardly from bracket 255 when the screw support 256 is removed. The screw support 256 can be reattached so it is not lost. This collapsed version of the hitch attached to the carrier 10 could be used when being placed into the automobile trunk of a golfer for transport to and from a course or when a golfer uses the detachable golf club carrier 10 as a standard pull or push cart (additional wheels could be attached with no intention of mounting to a motorized golf car 1). When connected in this mode, the single-cart collapsible hitch 250 and the detachable golf club carrier 10 rely on the same attachment points, upper hitch jaws 13, 33 connected to upper hitch tubes 251, 252 respectively and lower hitch tube 16 connected to lower hitch jaw 253 as when connected to motorized golf car 1.

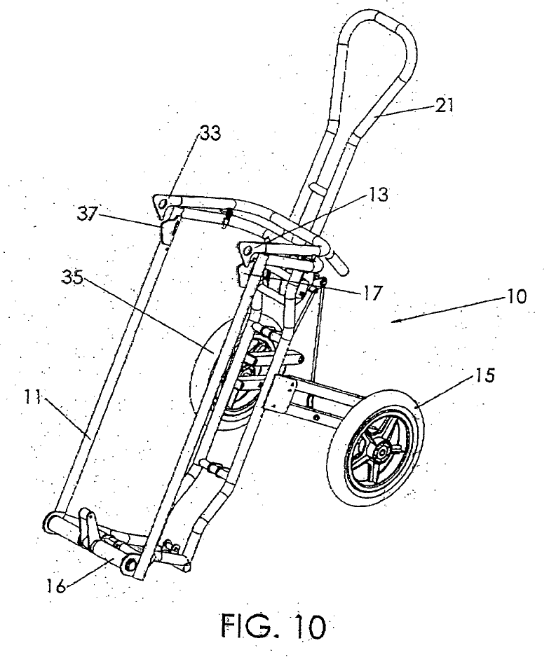

FIG. 10 shows an isometric view of the detachable golf club carrier 10.

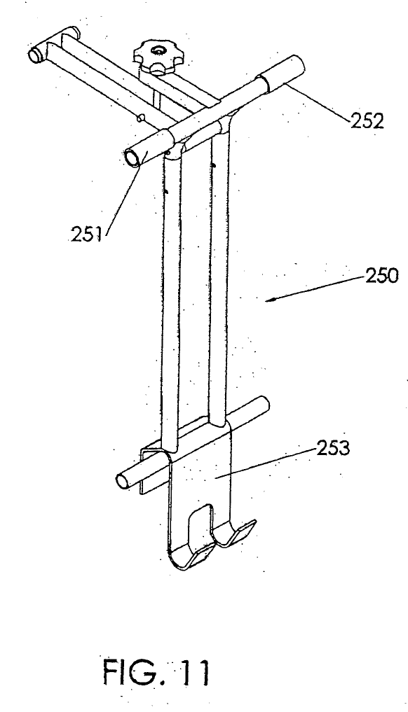

FIG. 11 shows an isometric view of the single-cart collapsible hitch 250 in the same configuration as it would be if installed into a motorized golf car 1.

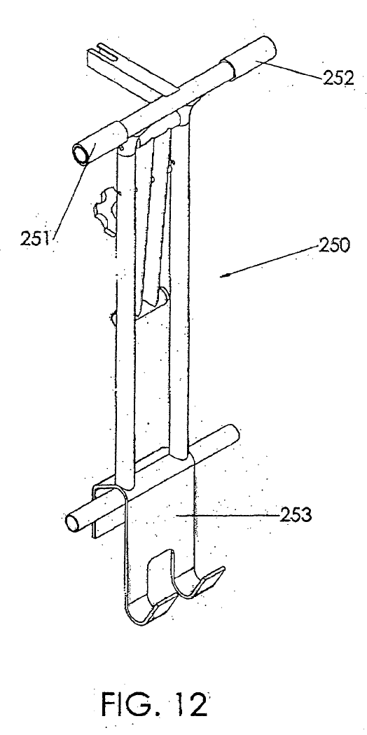

FIG. 12 shows an isometric view of the single-cart collapsible hitch 250 in the same configuration as it would be if not in use and connected to the detachable golf club carrier 10.

Removal of the golf bag carriers and hitches occurs in reverse order as described above.

Golf car as defined herein may be any low-speed vehicle (LSV) as defined by federal motor vehicle safety regulations.

### LIST OF REFERENCE NUMERALS

1—Golf car
2—Ground
5—Bagbay
6—Bag strap bracket
7—Bumper
10—First detachable golf club carrier
11—Carrier frame body
13, 33—Upper hitch jaw
14—Upper hitch Jaw handle
15, 35—Wheel
16—Lower hitch tube
17, 37—Upper hitch bracket
20—Golf Bag
21—Carrier handle
50—Two-cart hitch frame
51, 52—Upper hitch tube
53,153—Lower hitch jaw
110—Second detachable golf club carrier
151,152—Upper hitch tube (second detachable golf club carrier)
250—Single-cart collapsible hitch
251,252—Upper hitch tube (single-cart collapsible hitch)
253—Lower hitch jaw (single-cart collapsible hitch)
254—Extension
255—Bracket
256—Screw support

1-6. (canceled)

7. A golf bag carrier and hitch combination comprising:
a golf bag carrier; and
a hitch for attachment to a golf car, the hitch being carriable by the golf bag carrier and detachable from the golf bag carrier.

8. The golf club carrier and hitch combination as recited in claim 1 wherein the hitch includes a lower hitch jaw.

9. The golf club carrier and hitch combination as recited in claim 1 wherein the hitch includes a screw support for screwing the hitch to the golf car.

10. A method for using a golf bag carrier comprising:
attaching a hitch to a golf car;
attaching and detaching a golf club carrier to the hitch while the hitch is attached to the golf car; and
removing the hitch from the golf car and transporting the hitch using the golf club carrier.

11. A method for using a golf bag carrier comprising:
attaching a hitch to a golf club carrier;
transporting the hitch using the golf club carrier;
attaching the hitch to a golf car; and
detaching the golf club carrier from the hitch while the hitch remains on the golf car.
